(19) United States
(12) Patent Application Publication
(10) Pub. No.: US 2018/0036653 A1
(43) Pub. Date: Feb. 8, 2018

(54) DUAL CYCLONE SEPARATOR

(71) Applicant: JCI CYCLONIC TECHNOLOGIES LTD., Calgary (CA)

(72) Inventors: Kenneth Alfred Ernst, De Winton (CA); Matthew James Green, Chestermere (CA); Morley Everett Kocken, Sechelt (CA); Brendan Alexander Connolly, Langdon (CA)

(21) Appl. No.: 15/227,799

(22) Filed: Aug. 3, 2016

(51) Int. Cl. B01D 19/00; B04C 5/04; B04C 5/30; B04C 5/28

(52) U.S. Cl. CPC B01D 19/0057; B04C 5/28; B04C 5/04; B04C 5/30

(57) ABSTRACT

A cyclonic separator is taught, comprising at least two cyclonic chambers in the form of cylindrical tubes, having an upper inlet end and a lower liquid outlet end, a common tangential inlet in fluid communication with the upper end of each of the at least two cyclonic chambers, a gas outlet proximal to and extending upwardly from the upper ends of each of the at least two cyclonic chambers and a common outer shell surrounding the at least two cyclonic chambers, wherein said common tangential inlet extends through said common outer shell and into each of said at least two cyclonic chambers. A method for separation of a mixed heavy phase/light phase process stream is also taught.

### FIELD OF THE INVENTION

The present invention relates to cyclone separators for separating liquids from gases.

### BACKGROUND OF THE INVENTION

Cyclonic separator systems are commonly used to segregate immiscible phases of a process stream, such as when a process stream comprises a mixed liquid phase and gas phase. Separator systems are commonly used to separate immiscible entrained liquids from a gas phase of a mixed gas/liquid process stream, wherein the process stream enters cyclonic chambers through inlets that are tangential to the curvature of each of the cyclonic chambers. As a result of the velocity and the tangential angle at which the liquid/gas process stream enters the cyclonic chamber, centrifugal forces act on the process stream and cause it to spin around the curvature of the cyclonic chamber.

Centrifugal forces acting on each of the immiscible phases in the process stream, cause the phases to move either away from or towards the centre of the cyclonic chamber. A difference in the mass and densities of phases of the process stream cause the heavier phases to coalesce on the inner wall of the cyclonic chamber and travel in a downwards direction through the cyclonic chamber due to the force of gravity, while the lighter, or gaseous, phase(s) of the gas phase tend to remain closer to the centre of the cyclonic chamber forming a central upward moving column of lighter phase that exit through an aperture positioned in the upper covering of the cyclonic chamber.

To ensure effective light/heavy phase separation, the incoming process stream needs to flow at high velocity to create a greater centrifugal force for separation of the heavier phase from the lighter phase. As well, the gas outlet aperture must be designed to a minimum size based on how much lighter phase is being separated out. There are further limits to the design of the tangential inlets to each of the cyclonic chambers to create the desired high momentum and flow rate of the incoming process fluid.

An example of a prior art, single cyclonic separator can be seen in U.S. Pat. No. 3,481,118. An example of a prior art multicyclonic separator can be seen in U.S. Pat. No. 3,793,812.

Since the sizing of cyclonic chambers is a precise science, height and diameter dimensions are limited based on the stream to be separated, velocity and volume available. Typically, when using multiple separators, these specific size requirements lead to a height and diameter that is often too narrow and tall to withstand the high vibration commonly experienced in the separation environment. On example of such high vibration environment is when cyclone separators are used with reciprocating compressor scrubbers.

Separator dimensions can also limit the size of the lower area of the cyclonic separator, called a sump, which is used to collect liquids that are separated out of the entrained gas-liquid stream fed to the separator. Limitations to sump size lead to less than desirable residence time to separate out any entrained gases that may be trapped in the falling liquid.

As well, the external body of cyclonic separators must meet strict pressure vessel and welding requirements to ensure a level of integrity due to the high internal pressure, vibrations and velocities used in cyclonic separation. Involute or tangential inlets commonly used on cyclonic separators connect with the separator body in such a way that can prove difficult to meet the reinforcement requirements that are needed for the design of a pressure vessel.

As such, there is a need for an improved design of a cyclonic separator for separation of a liquid phase from a gas phase in a mixed process stream.

### SUMMARY

The present invention thus provides a cyclonic separator, comprising at least two cyclonic chambers in the form of cylindrical tubes, having an upper inlet end and a lower liquid outlet end, a common tangential inlet in fluid communication with the upper end of each of the at least two cyclonic chambers, a gas outlet proximal to and extending upwardly from the upper ends of each of the at least two cyclonic chambers and a common outer shell surrounding the at least two cyclonic chambers, wherein said common tangential inlet extends through said common outer shell and into each of said at least two cyclonic chambers.

The present invention further provides a method for separation of a mixed heavy phase/light phase process stream. The method comprises the steps of introducing the process stream into a cyclonic separator system through a common shell, via a common tangential inlet, guiding said process stream into at least two cyclonic chambers that are both in fluid communication with the common tangential inlet, allowing processes stream to swirl around an inner surface of each of said at least two cyclonic chambers to separate the heavy phase from the light phase, allowing the heavy phase to exit via a lower end of each of the at least two cyclonic chambers and allowing the light phase to rise through a central axis of each of the at least two cyclonic chambers and exit via a gas outlet on a upper end of each of the at least two cyclonic chambers.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a PERSPECTIVE view of one embodiment of the separator system of the present invention;

FIG. 2 is a top plan view of one embodiment of the separator system of the present invention;

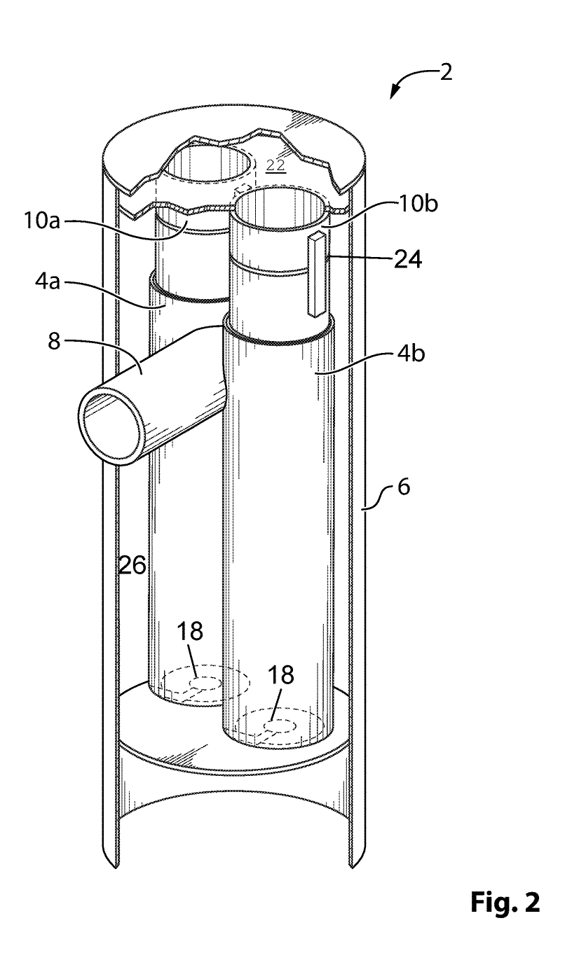

FIG. 3 is a front cross sectional view of one embodiment of the separator system of the present invention;

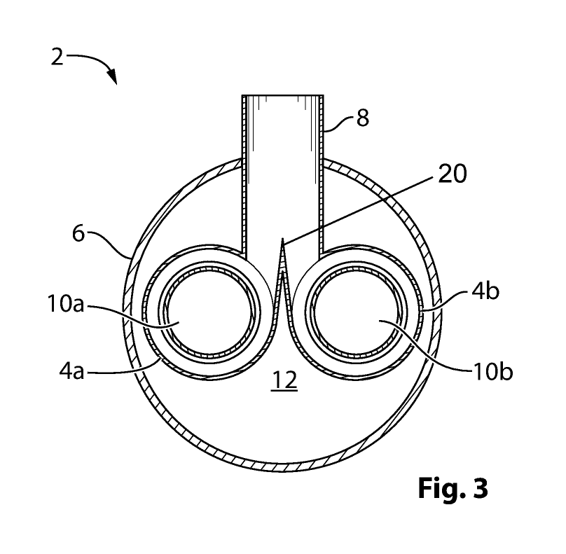

FIG. 4 is a perspective view of the cyclonic chambers of the present invention; and

FIG. 5 is a detailed view of the tangential inlet of one embodiment of the present invention.

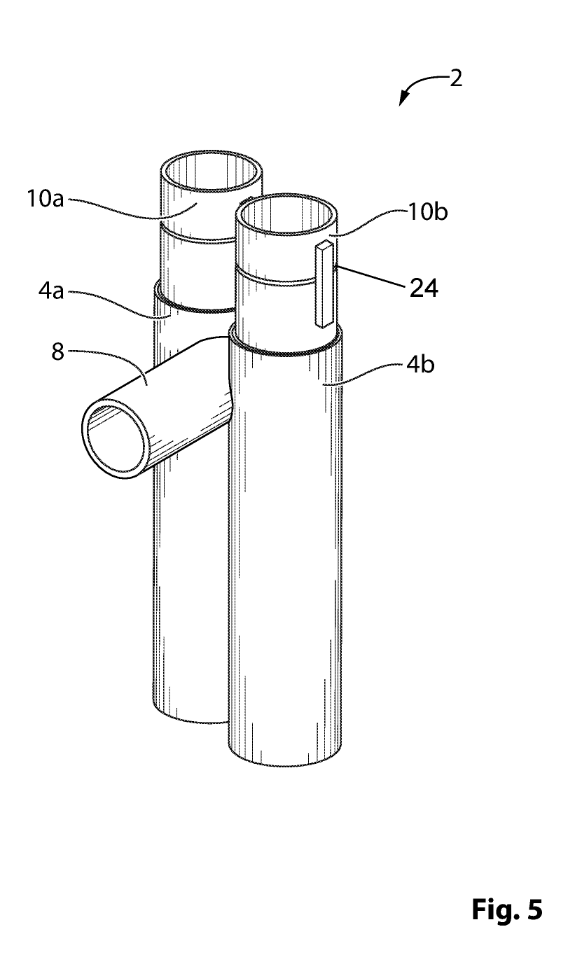

The drawings are not necessarily to scale and in some instances proportions may have been exaggerated in order more clearly to depict certain features.

### DETAILED DESCRIPTION OF VARIOUS EMBODIMENTS

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

With reference to the figures, the present invention provides a dual cyclonic separator system 2 having a common tangential inlet. The present separator system 2 combines two cyclonic separators or cyclonic chambers 4a, 4b in parallel, having a single common involute/tangential inlet 8. The pair of cyclonic chambers 4a, 4b are placed within a shell 6. The shell 6 preferably takes the shape of a vertically oriented cylinder, although it would be possible for the shell to take on other shapes such as a vertically oriented rectangular prism, without departing from the scope of the present invention.

The individual separators 4a, 4b are still sized in accordance with sizing specifications based on properties of the streams to be separated, including but not limited to relative densities and phases, inlet velocity, inlet pressure. However, by housing the pair of cyclonic chambers 4a, 4b within a shell 6, the dimensions of the shell 6 can be varied to provide stability and vibration resistance as required by the environmental conditions. Thus, by placing the cyclonic chambers 4a, 4b within a shell 6, there is more sizing flexibility.

The tangential inlet 8 is hollow and passes through the shell 6 and into fluid communication with each of cyclonic chambers 4a, 4b. The inlet 8 preferably has a circular cross sectional geometry, although a square or rectangular cross section geometry is also possible and within the scope of the present invention. While the figures illustrate the tangential inlet 8 as being at a right angle to the length of the shell 6 and to that of the cyclonic chambers 4a, 4b, it is also possible for the tangential inlet 8 to slope downwards at an angle greater than 90 degrees to the length of either the shell 6, or the cyclonic chambers 4a, 4b, or both, thus enhancing the gravity pull on the heavier liquid phase of the mixed process stream as it enters the separators 4a, 4b.

The process stream enters the separator system 2 via tangential inlet and generally divides into portions that enter each of the separators 4a, 4b. In a more preferred embodiment, a divider 20 may be inserted or other means may be used to divide the process stream into each of the cyclonic chambers 4a, 4b.

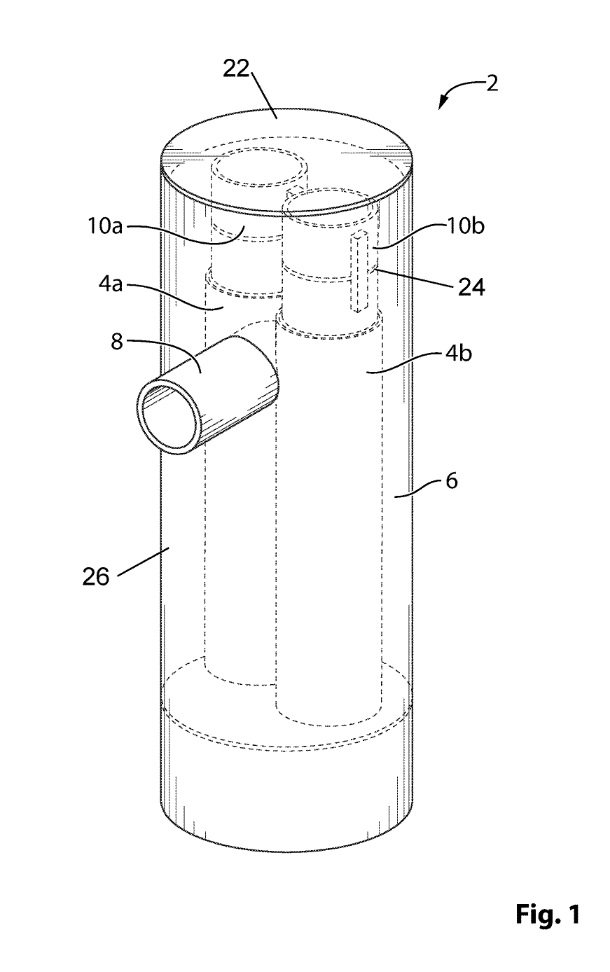

The present tangential inlet 8 connects externally with the outer shell 6 of the system 2, the geometry of the connection can be seen in FIG. 1, which is either curved circle, in the case of circular cross section inlet 8, or a curved rectangle or curved square, in the case of alternate inlet cross sectional geometries. These relatively simple angles and geometries of connection between the tangential inlet 8 and the shell 6 means that welding the inlet 8 to the shell 6 can be done simply without requiring special skill or tools. At the same time the weld can be made securely to meeting safety regulations and welding strength requirements need on external surfaces to which workers are exposed.

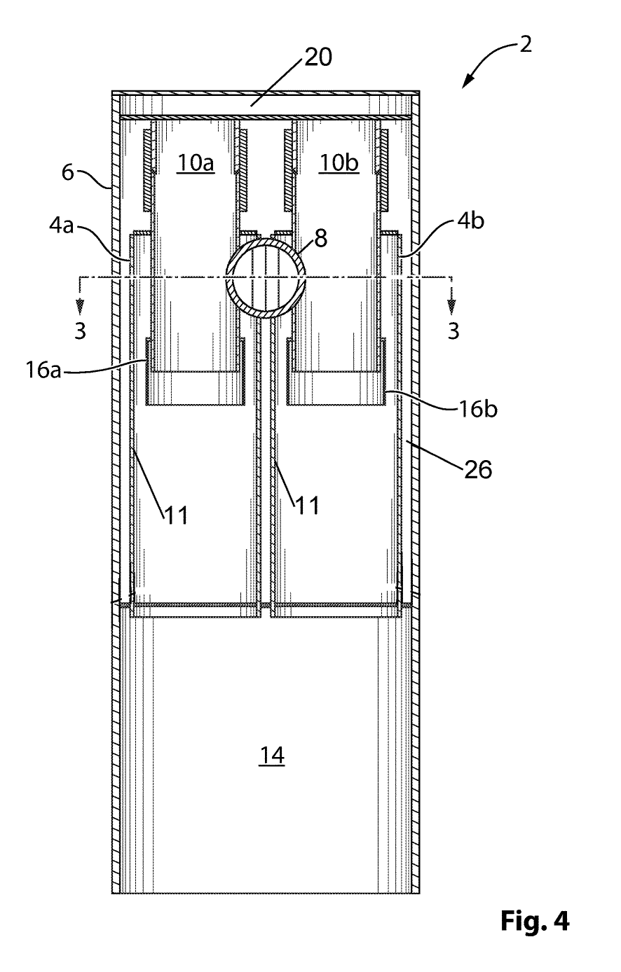

By contrast, internal to the shell 6, the tangential inlet 8 connects with each of the cyclonic chambers 4a, 4b at a relatively more complex angle and geometry as seen in FIG. 4, which would be much more difficult to weld to external safety regulations and weld strength ratings requirements. However, since the connection of tangential inlet 8 to the cyclonic separator pair 4a, 4b is internal; the welding of these components can be done without the necessity to meet strict external fabrication and welding requirements.

A process stream comprised of one or more immiscible gases entrained in one or more liquids enters the cyclonic chambers 4a, 4b through the common tangential inlet 6, and then the total volume of the process stream is substantially equally distributed between each separation column of each cyclonic chambers 4a, 4b. In a preferred embodiment, the substantially equal distribution of the total volume of the process stream may be facilitated by the divider 20, towards each of the cyclonic chambers 4A, 4B.

As the portions of the stream are spun around an inner surface 11 of each of the cyclonic chambers 4a, 4b, the heavier, or liquid, phases of the process stream is forced against, and continues along, the inner surface 11 by means of centrifugal force caused by the acceleration of the heavier, or liquid, phases of the process stream around the circumference of the inner surface 11, while simultaneously being pulled downwards by the force of gravity, which causes the heavier, or liquid, phases of the process stream to travel in a downward helical path. Preferably, the heavy, liquid phase exits a lower end of the cyclonic chamber via an outlet restriction on the lower end of the cyclonic chambers 4A, 4B, said outlet restriction (not shown) comprising a flat plate with an annular opening or core axial restriction. Alternately, the cyclonic chambers 4A, 4B may be designed with additional length and no outlet restriction, thus metering the ingress to the tubes of heavy separator fluids;

At the same time, the lighter, or gaseous, phases of the process stream, due to their lower masses and densities, collect in substantially the centre portion, or vertical axial core 10a, 10b of the cyclonic chambers 4a, 4b forming a central, upward moving column of lighter, or gaseous, phases that exit the cyclonic chambers 4a, 4b through the gas outlet 10a, 10b via a common gas chamber 22. In a preferred embodiment, one or more liquid creep preventers 16a, 16b may be added to the lower ends of gas outlets 10a, 10b to ensure that no liquid is misdirected or otherwise allowed to creep upwards and into the gas stream and travel upwards through the gas outlets 10a, 10b. The liquid creep preventers 16a, 16b may take any number of forms, it would be well understood by a person of skill in the art that any modification or addition to a lower end of the gas outlets 10a, 10b that would serve to deflect liquid from the gas outlets 10, 10b would be encompassed by the scope of the present invention.

Preferably, while the separation column of each cyclonic chamber 4a, 4b is independent, the separators 4a, 4b share a common tangential inlet 6 and also a common sump 14. In a further preferred embodiment of the present invention, a common lower area of the outer shell 6 forms the common sump 14, thereby replacing individual sumps for each single separator 4a, 4b. The common sump 14 collects liquids that are separated out of the entrained gas-liquid stream fed to the separator and which flow helically downwardly along the inner surfaces 11 of the cyclonic chambers 4a, 4b and into the sump 14. The present sump 14 provides a greater volume than the combined volumes of two single separator sumps. The increased volume allows for increased residence time for separation any entrained gases that may be trapped in the falling liquid. This improves separation efficiency and gas recovery. The released gases from the sump 14 travel upwardly through a second set of deflectors 18a, 18b proximal a lower end of the cyclonic chambers 4a, 4b through gas outlets 10a, 10b and out through the upper end of the cyclonic separator system 2.

To reduce the occurrence of entrained liquids in the upwardly travelling separated gas stream, many prior art separator systems make use of an external recycle arm in fluid communication with the gas outlets and extending downwardly to the separator sump. Such external recycle arms require welding to an outer surface of the separator and can affect the integrity of the separator system. In the present invention no such separate external recycle arm is required. Instead, a channel 24 is formed proximal a portion of each of the gas outlets 10a, 10b that extends beyond the cyclonic chambers 4a, 4b. The channel allows for entrained liquid in the upwards moving gas stream to exit the gas outlet tubes 10a, 10b. An inside cavity 26 of the outer shell 6 then acts as a recycle area, allowing the escaped liquid to fall through the inside of the shell to the sump 14.

The pairing of the cyclonic chambers 4a, 4b within the outer shell 6 allows for the shell 6 to be designed shorter, stubbier, and therefore more stable than a single tall, narrow separator that is sensitive to vibration. Since the sizing of cyclonic chambers is a precise science, height and diameter dimensions are limited based on the stream to be separated, velocity and volume available. The present design allows cyclonic chambers 4a, 4b to be designed to meet process requirements, while the outer shell 6 is designed with stability in mind, thereby achieving both goals.

The outer shell 6 is preferably cylindrical in geometry. It is generally easier and less expensive to manufacture, and is just as efficient or more efficient at separating an inlet stream comprised of immiscible gas and liquid phase than other, more complex and expensive geometries for an cyclonic separators, such as a conical or a frusto-conical geometry.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

What is claimed is:

1. A cyclonic separator, comprising:
a. at least two cyclonic chambers in the form of cylindrical tubes, having an upper end and a lower liquid outlet end;
b. a common tangential inlet in fluid communication with the upper end of each of the at least two cyclonic chambers;
c. a gas outlet inserted into and extending upwardly from each of the at least two cyclonic chambers; and
d. a common outer shell surrounding the at least two cyclonic chambers,
wherein said common tangential inlet extends through said common outer shell and into each of said at least two cyclonic chambers.

2. The cyclonic separator of claim 1, wherein common outer shell is sized to provide stability and vibration resistance.

3. The cyclonic separator of claim 1, further comprising a common sump in fluid communication with the lower liquid outlet ends of each of the at least two cyclonic chambers.

4. The cyclonic separator of claim 3, wherein the common sump is formed from a common lower area of the outer shell.

5. The cyclonic separator of claim 4, wherein an inner volume of the common outer shell serves as a recycle to recycle liquid trapped in the gas outlet back into the common sump.

6. The cyclonic separator of claim 1, wherein the tangential inlet is at an orientation relative to the length of the outer shell and to the cyclonic chambers selected from the group consisting of at a right angle and sloping downwards into the cyclonic chambers.

7. The cyclonic separator of claim 1 further comprising a deflector formed in the tangential inlet to divide a process stream into each of the at least two cyclonic chambers.

8. The cyclonic separator of claim 1, further comprising a common gas chamber in communication with an upper end of each of the gas outlets.

9. They cyclonic separator of claim 1, wherein a lower end of each of the gas outlets further comprise a liquid creep preventers prevent ingress of liquid into the gas outlets.

10. A method for separation of a mixed heavy phase/light phase process stream, said method comprising the steps of:
a. introducing the process stream into a cyclonic separator system through a common shell, via a common tangential inlet;
b. guiding said process stream into at least two cyclonic chambers that are both in fluid communication with the common tangential inlet;
c. allowing processes stream to swirl around an inner surface of each of said at least two cyclonic chambers to separate the heavy phase from the light phase;
d. allowing the heavy phase to exit via a lower end of each of the at least two cyclonic chambers; and
e. allowing the light phase to rise through a central axis of each of the at least two cyclonic chambers and exit via a gas outlet on a upper end of each of the at least two cyclonic chambers.

11. The method of claim 10, further comprising collecting the heavy phase in a common sump in fluid communication with the lower ends of each of the at least two cyclonic chambers.

12. The method of claim 11, wherein the common sump is formed from a common lower area of the outer shell.

13. The method of claim 12, further comprising recycling any stray heavy phase trapped in the light phase by allowing a stream of heavy phase to exit the central axis of each of the at least two cyclonic chambers, into an inner volume of the common shell and down to the common sump.

14. The method of claim 10, wherein the process stream is guided and substantially equally distributed into each of the at least two cyclonic chambers by means of a deflector.
